(19) United States
(12) Patent Application Publication
(10) Pub. No.: US 2007/0087648 A1
(43) Pub. Date: Apr. 19, 2007

(54) IMAGE DISPLAY UNIT MANUFACTURING METHOD AND APPARATUS

(76) Inventors: Takashi ENOMOTO, Fukaya-shi (JP); Katsumi Omote, Yokohama-shi (JP); Akiyoshi Yamada, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/563,905

(22) Filed: Nov. 28, 2006

Related U.S. Application Data
(63) Continuation of application No. PCT/JP05/11072, filed on Jun. 16, 2005.

(30) Foreign Application Priority Data
Jun. 18, 2004 (JP) 2004-180966
Aug. 3, 2004 (JP) 2004-226947

(51) Int. Cl. H01J 9/26; H01J 9/24; H01J 9/46; H01J 9/00

(52) U.S. Cl. 445/25; 445/24; 445/66

(57) ABSTRACT

When manufacturing a vacuum enclosure of an image display unit, degassing is performed by baking a back-side substrate provided with a plurality of strip-like slender spacer in a standing state. In this time, radiant heat is applied to the upper side of the spacer, to prevent the radiant heat reaching the side of the spacer, and to prevent an increase in a temperature difference between the spacer and back-side substrate.

### CROSS REFERENCE TO RELATED APPLICATIONS

This is a Continuation Application of PCT Application No. PCT/JP2005/011072, filed Jun. 16, 2005, which was published under PCT Article 21(2) in Japanese.

This application is based upon and claims the benefit of priority from prior Japanese Patent Applications No. 2004-180966, filed Jun. 18, 2004; and No. 2004-226947, filed Aug. 3, 2004, the entire contents of both of which are incorporated herein by reference.

### BACKGROUND OF THE INVENTION

1. Field of the Invention

The present invention relates to a method and apparatus for manufacturing an image display unit having a vacuum enclosure provided with a reinforcing member between opposed substrates.

2. Description of the Related Art

Recently, a liquid crystal display (LCD), a field emission display (FED) and a plasma display (PDP) are known as an image display unit having a flat plane panel vacuum enclosure. As a kind of FED, a surface-conduction-emitter display (SED) having a surface conduction electron-emitting element has been developed.

An SED has a front-side substrate and a back-side substrate, which are opposed with a predetermined clearance. These substrates are joined in the peripheral edge portion though a side wall made of glass and formed like a rectangular frame, constituting a flat plane panel vacuum enclosure whose inside is evacuated. A plurality of spacer is provided as a reinforcing member between the front-side substrate and back-side substrate, to withstand an atmospheric load applied to these substrates.

On the inside surface of the front-side substrate, three color florescent layers are formed. On the inside surface of the back-side substrate, a number of electron-emitting elements corresponding to each pixel are arranged as an electron emission source to excite and light the fluorescent layers. On the inside surface of the back-side substrate, a number of wires is provided in a matrix form to drive the electron-emitting elements, and the end of the wire is pulled out to the outside of the vacuum enclosure.

To operate the SED, apply a high voltage of approximately 10 kV over the substrates, and apply a driving voltage selectively to each electron emitting-element through a driving circuit connected to the wires. An electron beam is emitted selectively from each electron-emitting element, and is applied to the fluorescent layer, and the fluorescent layer is excited and lit, and a color image is displayed.

In such an SED, the thickness of a display unit can be reduced to several millimeters, realizing a light and thin display unit compared with a CRT used as a display of a current television and computer.

When manufacturing a vacuum enclosure of the SED, place a front-side substrate and a back-side substrate in a vacuum apparatus with a sufficient clearance taken therebetween, and while baking the substrates, degas the whole vacuum apparatus until it becomes a high vacuum. When a predetermined vacuum and temperature are attained, join the front-side substrate and back-side substrate through a side wall and a spacer. In this time, use a low-melting point metal capable of sealing at a relatively low temperature, as a sealing agent.

A spacer to withstand an atmospheric (vacuum) load acting on the front-side and back-side substrates of the vacuum enclosure is made of a thin plate-like member with both ends extending to the outside of an image display area, in order not to degrade the image display performance in its holding area. Both ends of the spacer are held by the substrate in the outside of the image display area.

Manufacturing of a vacuum enclosure having such a spacer requires a baking process of heating a substrate to approximately 400° C. and discharging a surface absorption gas not to generate unwanted gas from a substrate, and a subsequent heat treatment process including a step of cooling a substrate to approximately 120° C.

However, when heating a substrate (for example, a back-side substrate) with a spacer fixed upright in the baking process, as a spacer is a thin plate-like member as described above, and has a heat capacity extremely smaller than a substrate, a thermal expansion difference occurs between a spacer and a substrate, and a temperature of a spacer is increased extremely higher than a temperature of a substrate. As a result, a spacer is expanded, and may be bent or deformed. Such bend and deformation of a spacer decreases the strength as a reinforcing member, and causes a low yield in a later assembling process.

Also, in the cooling process, if a cooling plate is used to forcibly cool a substrate and reduce a cooling time, a large thermal expansion difference occurs between a substrate and a spacer, and a spacer may come off from a substrate or may be damaged. Therefore, it is necessary to set a cooling time longer to gradually cool a substrate. This causes a problem of decreasing productivity.

### BRIEF SUMMARY OF THE INVENTION

It is an object of the invention to provide a method and apparatus for manufacturing an image display unit having a vacuum enclosure provided with a reinforcing member (a spacer) to withstand an atmospheric load applied to front-side and back-side substrates, with high efficiency, yield and reliability.

To attain the object, a method of manufacturing a vacuum enclosure of an image display unit having a plurality of reinforcing member arranged upright on a plate surface of a pair of opposed substrates, according to an embodiment of the invention, wherein the method is an image display unit manufacturing method, characterized by a step of controlling a temperature of the reinforcing member so as to adjust a temperature of the reinforcing member close to a temperature of the substrate, in a heat treatment process to heat and cool the substrate provided with the reinforcing member.

Further an apparatus for manufacturing a vacuum enclosure of an image display unit having a plurality of reinforcing member arranged upright on a plate surface of a pair of opposed substrates, according to another embodiment of the invention, wherein the apparatus is an image display unit manufacturing apparatus comprising: a heat treatment means for heating and cooling the substrate provided with the reinforcing member; and a control means for controlling a temperature of the reinforcing member to close to a temperature of the substrate, when heating and cooling by the heat treatment means.

### BRIEF DESCRIPTION OF THE SEVERAL VIEWS OF THE DRAWING

FIG. 1 is a perspective external view of a vacuum enclosure of an SED according to an embodiment of the invention;

FIG. 2 is a sectional view of the vacuum enclosure of FIG. 1 taken along lines II-II;

FIG. 3 is a partially enlarged sectional view of the cross section of FIG. 2;

FIG. 4 shows a configuration of primary components of a heating means according to an embodiment of the invention, and a radiant heat control range;

FIG. 5 is a graph showing transition of temperature changes in a back-side substrate and a spacer in a heat treatment process according to an embodiment of the invention;

FIG. 6 shows a configuration of production-line of a manufacturing apparatus using a heating means according to an embodiment of the invention;

FIG. 7 shows a configuration of primary components of a substrate manufacturing apparatus according to an embodiment of the invention;

FIG. 8 shows a configuration of primary components of a substrate manufacturing apparatus according to another embodiment of the invention;

FIG. 9 is a graph showing an example of temperature control of a spacer according to each of the above embodiments of the invention;

FIG. 10 is a graph showing an example of temperature control of a spacer according to each of the above embodiments of the invention;

FIG. 11 is a graph showing an example of temperature control of a spacer according to each of the above embodiments of the invention; and

FIG. 12 shows a configuration of a production-line of a manufacturing apparatus according to each of the above embodiments of the invention.

### DETAILED DESCRIPTION OF THE INVENTION

Hereinafter embodiments of the invention will be explained in detail with reference to the accompanying drawings.

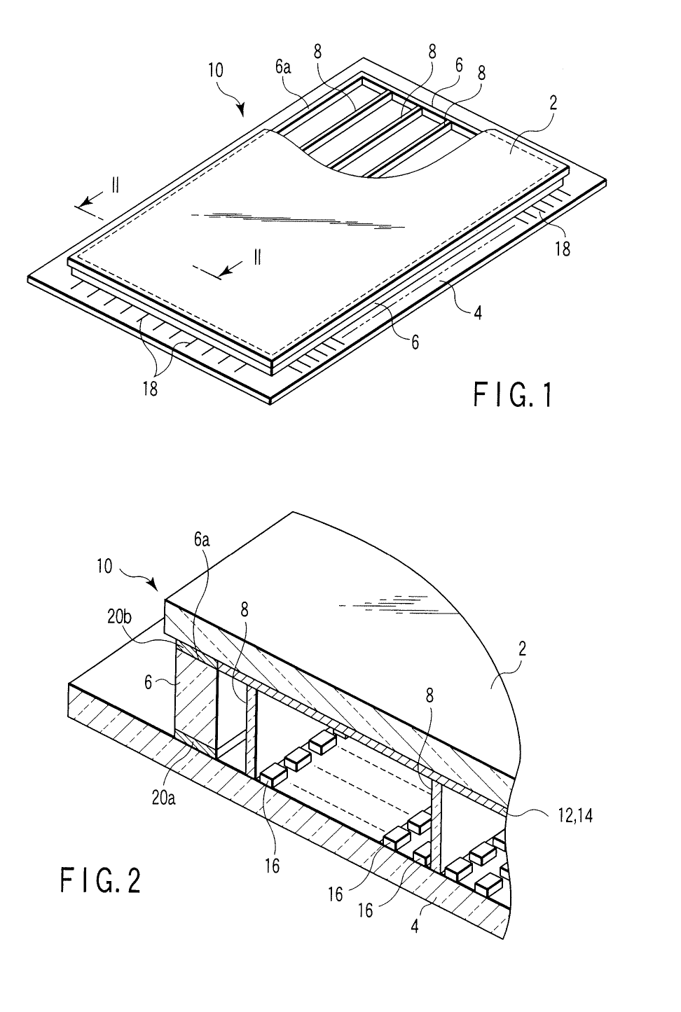

First, an SED is taken as an example of an image display unit having a vacuum enclosure according to the invention, and its configuration will be explained with reference to FIG. 1 to FIG. 3.

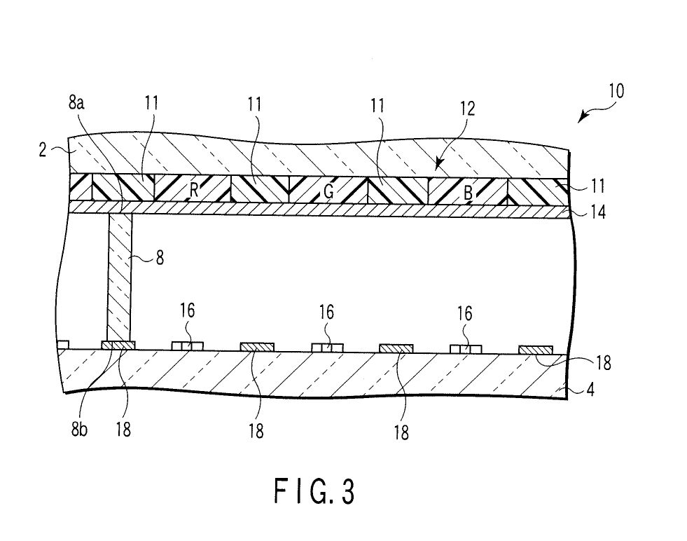

FIG. 1 is a perspective view of a vacuum enclosure 10 of an SED with a front-side substrate 2 partially broken away. FIG. 2 is a sectional view of the vacuum enclosure 10 of FIG. 1 taken along lines II-II. FIG. 3 is a partially enlarged sectional view of the cross section of FIG. 2.

As shown in FIG. 1 to FIG. 3, an SED has a front-side substrate 2 and a back-side substrate 4, each of which is made of a square glass plate. The substrates are opposed parallel with a clearance of 1.0-2.0 mm taken therebetween. The back-side substrate 4 is one size larger than the front-side substrate 2. The front-side substrate 2 and back-side substrate 4 are joined in the peripheral edge portion through a side wall 6 made of glass and formed like a rectangular frame, constituting a flat plane panel vacuum enclosure 10 whose inside is evacuated.

On the inside surface of the front-side substrate 2, a fluorescent screen 12 to function as an image display surface is formed. The fluorescent screen 12 is formed by arranging red, blue and green fluorescent layers R, G and B, and a light-shielding layer 11, side by side. These fluorescent layers are formed like a stripe or a dot. On the fluorescent screen 12, an aluminum metal back 14 is formed.

On the inside surface of the back-side substrate 4, a number of surface conduction electron-emitting elements 16 to emit an electron beam is provided as an electron emission source to emit an electron to excite and light the fluorescent layers R, G and B of the fluorescent screen 12. These electron-emitting elements 16 are arranged in columns and rows corresponding to each pixel, or each of the fluorescent layers R, G and B. Each electron-emitting element 16 consists of a not-shown electron-emitting part, and a pair of element electrodes to apply a voltage to the electron-emitting part. On the inside surface of the back-side substrate 4, a number of wires 18 for giving a driving voltage to each electron-emitting element 16 is provided in a matrix form, and the end of each wire is taken out to the outside of the vacuum enclosure 10.

The side wall 6 to function as a joining member is sealed to the peripheral edge portion of the front-side substrate 2 and back-side substrate 4 by a sealing agent 20 (20a, 20b), such as a low melting-point glass or metal, and joins these substrates. In this embodiment, a flit glass 20a is used to join the back-side substrate 4 to the side wall 6, and an indium 20b is used to join the front-side substrate 2 to the side wall 6.

The SED has a plurality of plate-like spacers as a reinforcing member between the front-side substrate 2 and back-side substrate 4, to maintain resistance to a vacuum or to withstand an atmospheric (vacuum) load to act on the substrates. Here, a plurality of slender (strip-like) spacer 8 made of thin glass plate is arranged in a standing state between the rectangular front-side substrate 2 and back-side substrate 4, along the longer side of the substrate at regular intervals.

Each spacer 8 has an upper end 8a contacting the inside surface of the front-side substrate 2 through the metal back 14 and the heat-shielding layer 11 of the fluorescent screen 12, and a lower end 8b contacting the wiring 18 provided on the inside surface of the back-side substrate 4. Therefore, these spacers 8 withstand an atmospheric pressure load to act on the front-side substrate 2 and back-side substrate 4 from the outside, and keep the inter-substrate clearance at a predetermined value.

Further, the SED has a not-shown voltage supply unit to apply an anode voltage over the metal back 14 of the front-side substrate 2 and the back-side substrate 4. The voltage supply unit applies an anode voltage to the back-side substrate 4 and metal back 14, so that a potential of the back-side substrate is set to zero, and a potential of the metal back is set to approximately 10 kV.

When displaying an image in the above SED, apply a voltage over the element electrodes of the electron emitting-element 16 through a not shown driving circuit connected to the wiring 18, emit an electron beam from the electron beam emitting-part of an optional electron-emitting element 16, and apply an anode voltage to the metal back 14. An electron beam emitted from the electron emitting-part is accelerated by the anode voltage, and collides with the fluorescent screen 12. Therefore, the R/G/B fluorescent layers of the fluorescent screen 12 are excited and lit, and a color image is display on the screen.

When manufacturing a vacuum enclosure of the SED configured as described above, a fluorescent screen 12, a front-side substrate 2 having a metal back 14, and a back-side substrate 4 having an electron-emitting element 16 and wiring 18, and which is joined to the side wall 6 and spacer 8, are prepared. The front-side substrate 2 and back-side substrate 4 are placed in a not-shown vacuum chamber, the chamber evacuated, and the front-side substrate 2 joined to the back-side substrate 4 through the side wall 6. This completes a vacuum enclosure 10 of an SED having a plurality of spacer 8.

In assembling the vacuum enclosure, a baking process of heating the substrates to approximately 400° C. and eliminating a surface absorption gas not to generate unwanted gas from the substrates, and a subsequent heat treatment process including a step of cooling the substrates to approximately 120° C., are necessary.

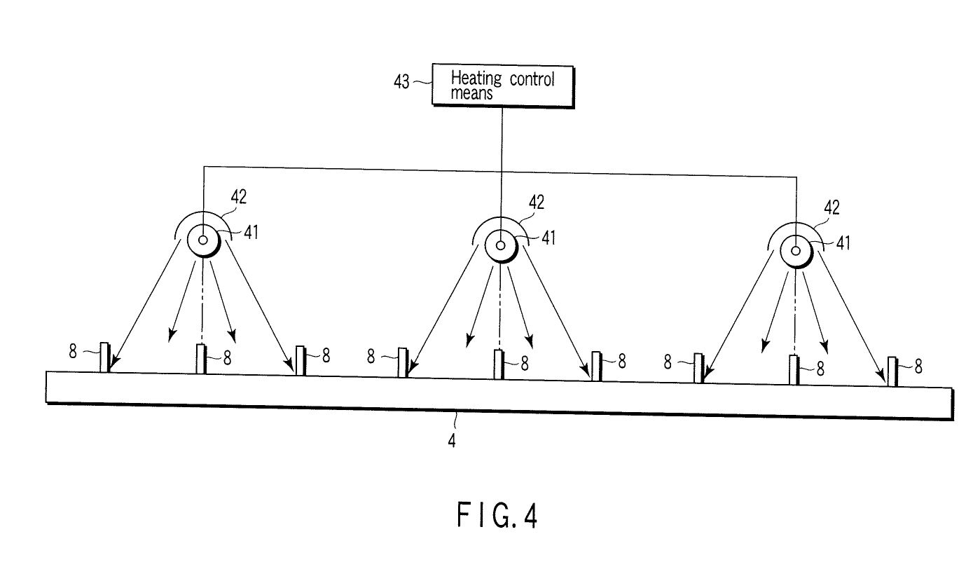

Hereinafter, an explanation will be given on a baking process according to the invention by referring to FIG. 4 to FIG. 6. A subsequent heat treatment process will be explained by taking an example of the back-side substrate 4 joined to the side wall 6 and spacer 8.

A baking process is a heat treatment process for heating a substrate to approximately 400° C. In this embodiment, in the baking process, a substrate is heated by applying radiant heat from right above the spacer 8, to prevent expansion, bending and deformation of the spacer caused by a temperature of the spacer increased extremely higher than a temperature of the back-side substrate 4.

FIG. 4 shows a configuration of primary components of a heating means, and an example of irradiation range control of radiant heat from a heater as a heating source. A heating means has a plurality of tubular heater 41, and a reflector 42 provided in each heater. In FIG. 4, a mechanism to support the heater 41 and reflector 42 is omitted. A mechanism to support a substrate at a predetermined position is also omitted.

Each heater 41 consists of a tubular lamp heater adjusted to the length of the spacer 8. Each heater 41 is positioned and arranged in the substantially vertical direction to the back-side substrate 4 supported at a predetermined position as an object of a baking process, that is, at the position to radiate radiant heat to right above the spacer 8 fixed to the plate surface of the corresponding back-side substrate 4.

In the embodiment shown in FIG. 4, the heater 41 is arranged to radiate radiant heat to right above the spacer 8 at every two of the spacers 8 arranged on the plate surface of the back-side substrate 4. Each heater 41 is controlled by a heating control means 43.

As the back-side substrate 4 is heated by applying radiant heat to right above the spacer 8, it is prevented that the thin plate-like spacer 8 standing on the back-side substrate 4 is rapidly heated by directly receiving the radiant heat on its side. This prevents an extreme temperature difference between the back-side substrate 4 and spacer 8, and prevents a problem of deforming and bending the spacer 8.

In order to increase the above effect, in this embodiment, a reflector 42 is provided in each heater 41 to apply radiant heat to right above the spacer 8, and the reflector 42 controls the reflecting direction and applying range of the radiant heat from the heater 41. Namely, as the reflector 42 controls the reflecting direction and applying range of the radiant heat from the heater 41, a spacer 8 arranged not just under the heater 41 can be baked just like a spacer 8 arranged just under the heater 41. Therefore, radiant heat can be controlled not to generate an extreme temperature difference between the back-side substrate 4 and spacer 8, and the back-side substrate 4 can be efficiently heated.

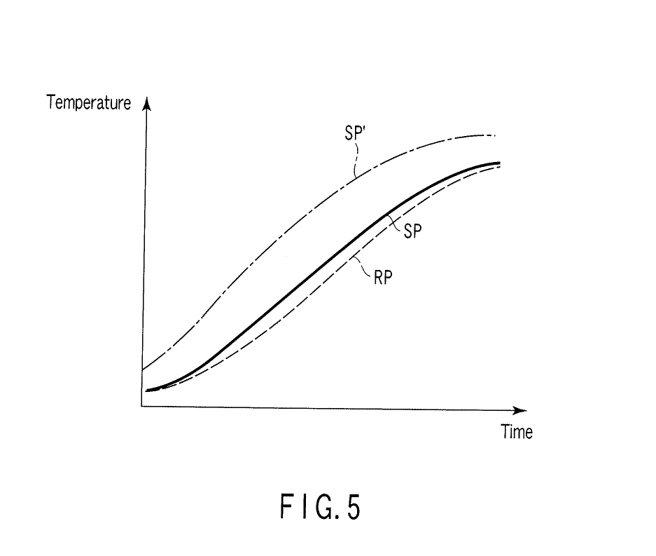

FIG. 5 shows the transition of temperature changes in the back-side substrate 4 and spacer 8 when heating the back-side substrate 4 by the heating means according to the above-mentioned embodiment. Here, the temperature curve of the back-side substrate 4 is indicated by RP, and the temperature curve of the spacer 8 is indicated by SP. For comparison purposes, SP′ indicates the temperature curve of the spacer 8 when the spacer 8 and rear substrate 4 are evenly heated by a heating means not considering the position of the spacer 8, not by a heating means considering the position of the spacer 8 as in the above-mentioned embodiment.

By using the heating means according to the embodiment shown in FIG. 4, the temperature curve of the spacer 8 can be shifted from the chain line SP′ to the solid line SP, thereby a problem of generating an extreme temperature different between the spacer 8 and back-side substrate 4 can be solved.

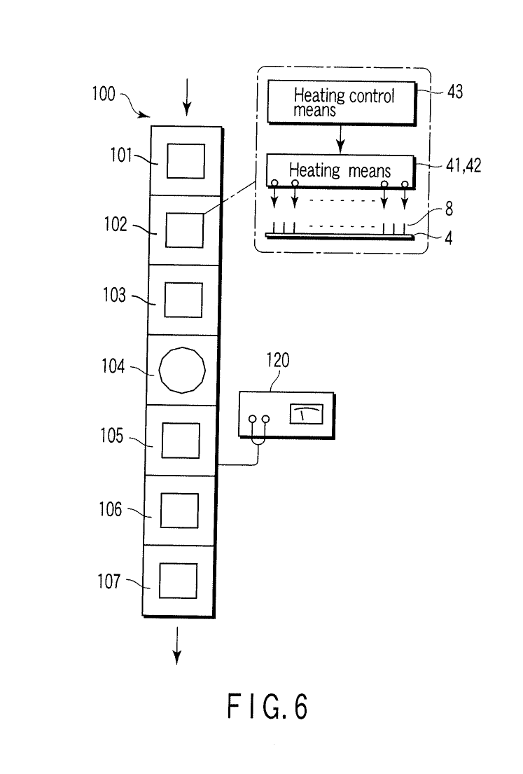

FIG. 6 shows the simplified structure of a vacuum processor 100, which manufactures a vacuum enclosure of an image display unit by using the heating means shown in FIG. 4.

The vacuum processor 100 has a loading chamber 101, a baking and electron beam cleaning chamber 102, a cooling chamber 103, a getter film evaporating chamber 104, an assembling chamber 105, a cooling chamber 106, and an unloading chamber 107. Each chamber of the vacuum processor 100 is constructed to be capable of vacuum processing, and evacuated when manufacturing a vacuum enclosure of an SED. Each chamber is connected by a not-shown gate value.

When manufacturing the vacuum enclosure 10 by using the above vacuum processor 100, the front-side substrate 2 and back-side substrate 4 are put in the loading chamber 101, the chamber evacuated, and the substrates sent to the baking and electron beam cleaning chamber 102. In the baking and electron beam cleaning chamber 102, the substrates 2 and 4 and other members including the components packed on the substrates are heated to approximately 400° C., a surface absorption gas of each substrate is eliminated, and the whole surface of the fluorescent screen and electron-emitting element is cleaned by deflection scanning of an electron beam.

In the baking process in the baking and electron beam cleaning chamber 102, the substrates are heated to approximately 400° C. not to generate unwanted gas during the processing, and exhaust a surface absorption gas. In this heat treatment process, especially in the step of baking the back-side substrate 4, the heating means shown in FIG. 4 is used. Namely, as described above, as the back-side substrate 4 is heated by applying radiant heat to right above the spacer 8, it is prevented that the thin plate-like spacer 8 standing on the back-side substrate 4 is rapidly heated by directly receiving the radiant heat on its side and that an extreme temperature difference occurs between the back-side substrate 4 and spacer 8, causing deforming and bending of the spacer 8. Further, the reflector 42 controls the reflecting direction and applying range of the radiant heat from the heater 41, so that an extreme temperature difference is not generated between the back-side substrate 4 and the spacer 8 arranged not just under the heater 41, just like the spacer 8 arranged just under the heater 41.

After being degassed in the baking and electron beam cleaning chamber 102, the front-side substrate 2 and back-side substrate 4 are sent to the cooling chamber 103 having the characteristics of the invention as described later in detail, and cooled there down to approximately 120° C. The cooled front-side substrate 2 and back-side substrate 4 are sent to the getter film evaporating chamber 104, where a barium film is formed as a getter film on the outside of a fluorescent layer. The substrates are then sent to the assembling chamber 105, where the substrates are sealed by fusing indium as a sealing member by energizing a power supply 120, thereby forming a vacuum enclosure. The sealed vacuum enclosure is sent to the cooling chamber 106, cooled down to a room temperature, and taken out from the unloading chamber 107. The vacuum enclosure 10 of an SED is manufactured by the above processes.

As described above, by heating the back-side substrate 4 by applying radiant heat to right above the spacer 8 in the back-side substrate 4 heating process, it is prevented that the thin plate-like spacer 8 standing on the back-side substrate 4 is rapidly heated by directly receiving the radiant heat on its side. This solves the problem of deforming and bending the spacer 8 caused by an extreme temperature difference between the back-side substrate 4 and spacer 8. Further, the reflector 42 controls the reflecting direction and applying range of the radiant heat from the heater 41, so that an extreme temperature difference is not generated between the back-side substrate 4 and the spacer 8 arranged not just under the heater 41, just like the spacer 8 arranged just under the heater 41. This efficiently controls the heating of the back-side substrate 4.

In each of the above-mentioned embodiments, a lamp heater is used as a spacer heating means. But, the heating means is not limited to a lamp heater. Other heating elements such as tungsten or titanium heater wire and a quarts heater may be used. The positions of a spacer and a heater are not limited to those in the embodiment. They are placed in 1:1 for example. The substrate configuration and production-line are not limited to those shown in the embodiment. They may be modified without departing from the essential characteristics of the invention.

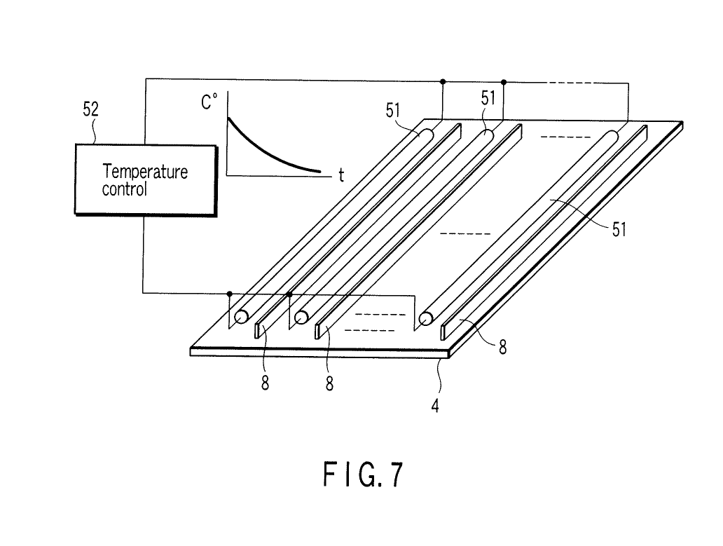

Next, a cooling process according to the invention will be explained in detail with reference to FIG. 7 to FIG. 12.

In the cooling process after the above-mentioned baking process, if the back-side substrate 4 is forcibly cooled within a short time by using a cooling means such as a cooling plate, the spacer 8 is cooled fast, because the heat capacity of the spacer 8 is extremely smaller than the back-side substrate 4, and a large temperature difference occurs between the spacer 8 and back-side substrate 4. As a result, the spacer 8 may peel off from the back-side substrate 4, or damaged, and a yield is extremely decreased.

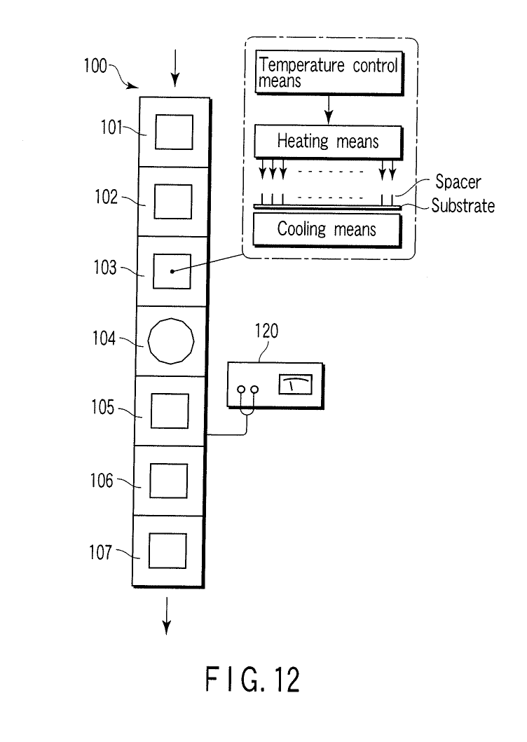

To prevent this problem, as shown in FIG. 12, a temperature of the spacer 8 is controlled in a cooling atmosphere in the cooling chamber 103 by using a temperature control means and a heating means, not to increase a temperature difference between the spacer 8 and the back-side substrate 4 cooled by a cooling means, to a degree to cause peel-off or damage of the spacer 8. The apparatus in FIG. 12 is the same as that in FIG. 6.

Namely, the vacuum processor 100 has a loading chamber 101, a baking and electron beam cleaning chamber 102, a cooling chamber 103, a getter film evaporating chamber 104, an assembling chamber 105, a cooling chamber 106, and an unloading chamber 107. Therefore, explanation of the contents explained in FIG. 6 will be omitted.

The cooling chamber 103 of the vacuum processor 100 cools the front-side substrate 2 and back-side substrate 4 degassed in the baking and electron beam cleaning chamber 102, down to approximately 120° C. In this cooling chamber, as described above, a temperature of the spacer 8 is controlled in a cooling atmosphere by using a temperature control means and a heating means, not to increase a temperature difference between the spacer 8 and the back-side substrate 4 cooled by a cooling means, to a degree to cause peel-off or damage of the spacer 8.

When cooling the back-side substrate 4 in the cooling chamber 103, the cooling temperature is controlled in the cooling atmosphere so as to adjust a temperature of the spacer 8 to a temperature of the back-side substrate 4, and even if the back-side substrate 4 is a large rectangle, the spacer 8 provided along the longer side of the substrate 4 is prevented from damages or peeling off from the substrate 4, and an SED with a high yield can be efficiently manufactured within a short time.

FIG. 7 shows an outline of a manufacturing apparatus according to an embodiment of the invention, having a function of controlling a temperature of the spacer 8 in such a cooling atmosphere. Here, only the primary components are shown, excluding a cooling means such as a cooling plate, a reflection plate and a structure to support a heater as a heating source of a heating means, provided in the cooling chamber 103 to cool the back-side substrate 4 heated in the baking process.

As described above, in the plate surface of the back-side substrate 4 placed in a cooling atmosphere in a cooling chamber, a plurality of spacer 8 is joined along the longer side of the substrate standing at regular intervals. A heating element as a heating source of a heating means to give radiant heat to each spacer 8 is provided for each spacer 8. Here, as a heating element to give radiant heat to the spacer 8, a plurality of lamp heaters 51 is provided diagonally above the spacer 8 by keeping a distance enough to give radiant heat.

Each lamp heater 51 is connected to a temperature controller 52 to function as a temperature control means. The temperature controller 52 energizes the lamp heater 51 and controls its heating (lighting) according to a preset temperature profile, and heats the corresponding spacer 8 on the substrate by applying radiant heat.

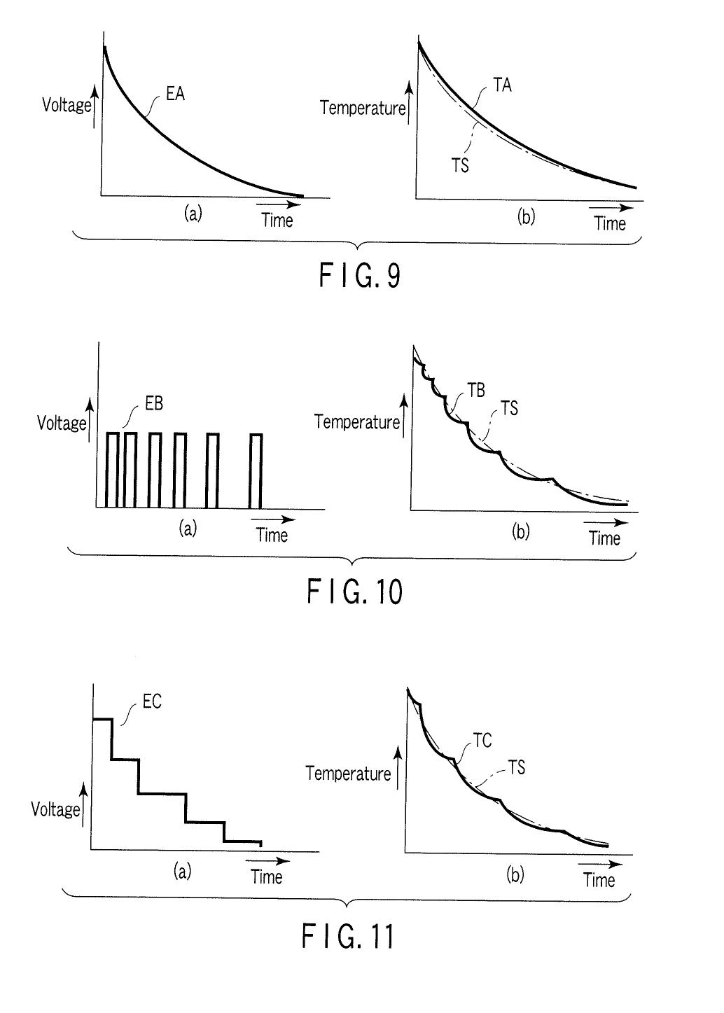

Namely, the temperature controller 52 controls the lamp heater 51, thereby controls the temperature of the spacer 8 on the back-side substrate 4 put in the cooling atmosphere in the cooling chamber 103, so as to adjust to a temperature decrease in the back-side substrate 4. The temperature controller 52 controls energization of the lamp heater 51 according to the preset temperature profile, so that a temperature of the spacer 8 always falls within a preset temperature difference range (e.g., 15° C.) with respect to a temperature of the cooled back-side substrate 4. A concrete energizing and control means for the lamp heater 15 will be described later with reference to FIG. 9 to FIG. 11.

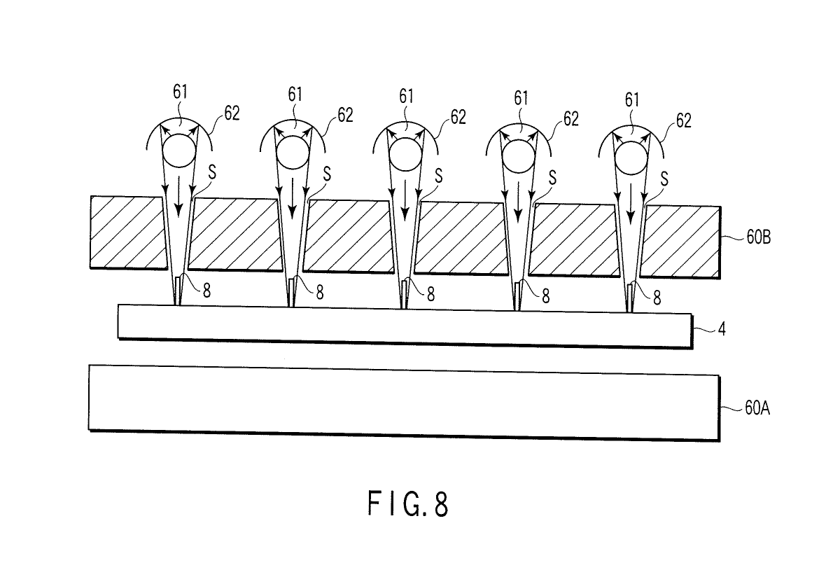

FIG. 8 shows a configuration of a more concrete example of a manufacturing apparatus according to the invention, having a temperature control function of the spacer 8 in a cooling atmosphere. Here, a configuration incorporating the temperature control function of the spacer 8 is shown, in addition to a structure for cooling the back-side substrate 4 by opposing the cooling surfaces of cooling plates 60A and 60B on both sides of the back-side substrate 4 as a cooling object. In this embodiment, it is assumed that heating (lighting) of a lamp heater 61 described later is controlled by the temperature controller 52 shown in FIG. 7 according to a preset temperature profile.

As described hereinbefore, a plurality of spacers 8 is provided at regular intervals in the direction parallel to the longer side of the back-side substrate 4 on one side of the back-side substrate 4 as a cooling object (on the surface opposite to the front-side substrate 2). The spacer 8 is made of a thin plate-like glass, and fixed at both ends of or at several positions in the back-side substrate 4.

The cooling chamber 103 is provided with a pair of cooling plates 60A and 60B to simultaneously cool both sides of the back-side substrate 4 as a cooling object. On one of the pair of cooling plates 60A and 60B, or the cooling plate 60B having a cooling surface opposite to the plate surface provided with the spacer 8 of the back-side substrate 4 as a cooling object, there is provided a slit-like through hole (S) adjusted to the length of the spacer 8 to give radiant heat to the spacer 8 through the cooling plate 60B. Above this through hole (S), a lamp heater 61 and heat reflection plate 62 adjusted to the length of the spacer 8 are provided very close to the cooling plate 60B. Though a structure to support the lamp heater 61 is not shown here, the heat reflector 62 may be provided as one body with the structure to support the lamp heater 61.

As already described in the cooling of the substrate 4 in the cooling chamber 103, energization of the lamp heater 61 is controlled by the temperature controller 52 according to a preset temperature profile, and is cooled while being temperature controlled so as to adjust a temperature of the spacer 8 to a temperature of the back-side substrate 4 in a cooling atmosphere.

In this time, the heat (heat source) emitted from the lamp heater 61 is, directly or after once reflected on the heat reflector 62, applied to the spacer 8 on the back-side substrate 4 through the slit-like through hole (S) provided on the cooling plate 60B, and heats the spacer 8 by radiant heat, and adjusts a temperature of the spacer 8 to a temperature of the back-side substrate 4.

FIG. 9 to FIG. 11 show examples of energization control of a lamp heater in the above embodiment. Energization of a lamp heater is controlled by the above temperature controller 52 according to a preset temperature profile.

The example of energization control shown in FIG. 9 is to continuously energize a lamp heater, in which a voltage (EA) applied to a lamp heater is continuously and variably controlled to adjust a temperature (TA) of the spacer 8 to a temperature (TS) of the back-side substrate 4, in a cooling atmosphere of the back-side substrate 4.

The example of energization control shown in FIG. 10 is to intermittently energize a lamp heater, in which a duty of certain time voltage (EB) applied to a lamp heater is variably controlled, so that a temperature (TB) of the spacer 8 usually falls within a preset temperature difference range with respect to a temperature (TS) of the back-side substrate 4, in a cooling atmosphere of the back-side substrate 4.

The example of energization control shown in FIG. 11 is to stepwise energize a lamp heater, in which a voltage (EC) applied to a lamp heater is stepwise controlled, so that a temperature (TC) of the spacer 8 usually falls within a preset temperature difference range with respect to a temperature (TS) of the back-side substrate 4, in a cooling atmosphere of the back-side substrate 4.

By the above energization control of a lamp heater, when cooling the back-side substrate 4 by using a cooling means, a temperature difference between the back-side substrate 4 and the spacer 8 provided on the substrate can be kept in a predetermined range, thereby preventing damages or coming-off of the spacer 8 from the back-side substrate 4 caused by a temperature difference between the spacer 8 and back-side substrate 4. Therefore, a high-yield SED can be efficiently manufactured within a short time.

In the embodiments described hereinbefore, a lamp heater is used as a means of heating the spacer 8. But, the heating means is not limited to a lamp heater. Other heating elements such as tungsten or titanium heater wire and a quarts heater may be used. A means for giving radiant heat to the spacer 8 through a cooling plate is not limited to a slit-like through hole. Small holes formed like a line or an elongate hole formed along the spacer 8 may be used. It is also permitted to mount a heater for heating a spacer on a cooling surface of a cooling plate, without forming an opening in a cooling plate. Further, the heater used for a heating means, the structure of a heating means, and the structure of a substrate as an cooling object are not limited to those described in the above embodiments. They are applicable to various plates for heat treatment without departing from the essential characteristics of the invention.

Further, in the above-mentioned embodiments, an assembly with a plurality of spacer 8 joined on the plate surface of the back-side substrate 4 is taken as an object of processing. The processing object may be an assembly with the spacer 8 joined to the front-side substrate 2.

According to a method and apparatus for manufacturing an image display unit, it is possible to efficiently manufacture a vacuum enclosure having a reinforcing member (a spacer) to withstand an atmospheric load applied to a front-side substrate and a back-side substrate, with high efficiency, yield and reliability.

What is claimed is:

1. A method of manufacturing a vacuum enclosure of an image display unit having a plurality of reinforcing member arranged upright on a plate surface of a pair of opposed substrates,
wherein the method is an image display unit manufacturing method, characterized by a step of controlling a temperature of the reinforcing member so as to adjust a temperature of the reinforcing member close to a temperature of the substrate, in a heat treatment process to heat and cool the substrate provided with the reinforcing member.

2. The image display unit manufacturing method according to claim 1, wherein when the substrate provided with the reinforcing member is heated in the heat treatment process, radiant heat is applied to the upper side of the reinforcing member substantially orthogonal to the plate surface of the substrate.

3. The image display unit manufacturing method according to claim 2, wherein the reinforcing member is shaped like a strip to support the opposed plate surfaces of the pair of substrates.

4. The image display unit manufacturing method according to claim 3, wherein the heat treatment process heats the substrate provided with the reinforcing member to a preset temperature by using fewer heaters than the number of the reinforcing members.

5. The image display unit manufacturing method according to claim 4, wherein the heat treatment process has a means of controlling radiant heat applied from the heater to the substrate and reinforcing member, so as to heat the substrate and reinforcing member within a predetermined temperature difference range.

6. The image display unit manufacturing method according to claim 1, wherein when the substrate provided with the reinforcing member is cooled in the heat treatment process, the reinforcing member is heated in a cooling atmosphere.

7. The image display unit manufacturing method according to claim 6, wherein when the reinforcing member is heated in the cooling atmosphere, radiant heat is applied to the reinforcing member, so that a temperature difference between the substrate and reinforcing member falls within a preset temperature difference range.

8. The image display unit manufacturing method according to claim 7, wherein a cooling plate which has a cooling surface opposite to a plate surface of the substrate and has an opening corresponding to a position of the reinforcing member on the cooling surface, is opposed to the plate surface of the substrate; and
the substrate is cooled by the cooling plate, and
the radiant heat is applied to the reinforcing member through an opening provided in the cooling plate.

9. The image display unit manufacturing method according to claim 8, wherein the reinforcing member is shaped like strip, and arranged in two or more number at regular intervals in one direction on the plate surface of the substrate and in a standing state in the other direction between both ends of the substrate.

10. The image display unit manufacturing method according to claim 9, wherein when the reinforcing member is heated in the cooling atmosphere, a heating temperature of the heater to emit radiant heat is continuously controlled to gradually attenuate a heating value of the heater.

11. The image display unit manufacturing method according to claim 9, wherein when the reinforcing member is heated in the cooling atmosphere, the heater to emit radiant heat is intermittently or stepwise energized to gradually attenuate a heating value of the heater.

12. The image display unit manufacturing method according to any one of claims 1 to 11, wherein the heat treatment process to heat and cool the substrate is executed in a vacuum chamber.

13. An apparatus for manufacturing a vacuum enclosure of an image display unit having a plurality of reinforcing member arranged upright on a plate surface of a pair of opposed substrates,
wherein the apparatus is an image display unit manufacturing apparatus comprising:
a heat treatment means for heating and cooling the substrate provided with the reinforcing member; and
a control means for controlling a temperature of the reinforcing member to close to a temperature of the substrate, when heating and cooling by the heat treatment means.

14. The image display unit manufacturing apparatus according to claim 13, further comprising a heating means for applying radiant heat to the upper side of the reinforcing member substantially orthogonal to a plate surface of the substrate, when heating the substrate.

15. The image display unit manufacturing apparatus according to claim 14, wherein the reinforcing member is shaped like a strip to support the opposed plate surfaces of the pair of substrates.

16. The image display unit manufacturing apparatus according to claim 15, wherein the heating means has fewer heaters than the number of reinforcing members, and heats the substrate provided with the reinforcing member to a preset temperature by using the heaters.

17. The image display unit manufacturing apparatus according to claim 16, the heating means has a reflector to control radiant heat applied from the heater to the substrate and reinforcing member, so that the reinforcing member and substrate are heated within a predetermined temperature difference range.

18. The image display unit manufacturing apparatus according to claim 13, further comprising a heating means for heating the reinforcing member in a cooling atmosphere, when cooling the substrate.

19. The image display unit manufacturing apparatus according to claim 18, wherein the control means controls the heating means, so that a temperature difference between the substrate and reinforcing member falls within a preset temperature difference range in the cooling atmosphere.

20. The image display unit manufacturing apparatus according to claim 19, wherein the heat treatment means has a cooling plate having a cooling surface to cool the substrate opposite to the plate surface of the substrate, and having an opening shaped like a slit, or an opening shaped like an elongate hole, or openings arranged at regular intervals like a line, corresponding to a position of the reinforcing member on the cooling surface; and
the heating means applies radiant heat to the reinforcing member arranged in the substrate through the opening provided in the cooling plate.

21. The image display unit manufacturing apparatus according to claim 20, wherein the reinforcing member is shaped like a strip, and arranged in two or more number at regular intervals in one direction on the plate surface of the substrate and in a standing state in the other direction between both ends of the substrate.

22. The image display unit manufacturing apparatus according to claim 21, wherein the heating means has a heater and an current control means to control a current of the heater; and the current control means controls current of the heater, so that a temperature difference between the substrate and reinforcing member falls within a preset temperature difference range in the cooling atmosphere.

23. The image display unit manufacturing apparatus according to claim 22, wherein the heating means includes a reflector which converges the radiant heat of the heater in an opening provided on a cooling surface of the cooling plate.

24. The image display unit manufacturing apparatus according to claim 22, wherein the current control means continuously controls a heating temperature of the heater so as to gradually attenuate a heating value of the heater, in the cooling atmosphere.

25. The image display unit manufacturing apparatus according to claim 22, wherein the current control means intermittently or stepwise energizes the heater so as to gradually attenuate a heating value of the heater, in the cooling atmosphere.

26. The image display unit manufacturing apparatus according to claim 14, wherein the heating means has a heater and an current control means to control a current of the heater; and the current control means controls the current of the heater, so that a temperature difference between the substrate and reinforcing member falls within a preset temperature difference range in the cooling atmosphere.

27. The image display unit manufacturing apparatus according to claim 26, wherein the current control means continuously controls a heating temperature of the heater so as to gradually attenuate a heating value of the heater, in the cooling atmosphere.

28. The image display unit manufacturing apparatus according to claim 26, wherein the current control means intermittently or stepwise energizes the heater so as to gradually attenuate a heating value of the heater, in the cooling atmosphere.
